(19) United States
(12) Patent Application Publication
(10) Pub. No.: US 2004/0026998 A1
(43) Pub. Date: Feb. 12, 2004

(54) Low voltage electrified furniture unit

(76) Inventors: Jay M. Henriott, Jasper, IN (US); Keith E. Metcalf, Jasper, IN (US)

Correspondence Address: BAKER & DANIELS, 111 E. WAYNE STREET, SUITE 800, FORT WAYNE, IN, 46802

(21) Appl. No.: 10/459,740

(22) Filed: Jun. 12, 2003

Related U.S. Application Data
(60) Provisional application No. 60/398,269, filed on Jul. 24, 2002.

(51) Int. Cl. B60L 1/00

(52) U.S. Cl. 307/9.1

(57) ABSTRACT

Low voltage DC electrification of a furniture unit is provided by a power supply having a rechargeable battery and an automobile passenger compartment power outlet which is electrically connected to the rechargeable battery. In one embodiment, the power supply is mounted to a furniture unit having a height adjustable worksurface, the lift motors of the furniture unit also being powered by the power supply. Additionally, the power supply may include a control device prioritizing recharging of the battery to times of off-peak or low-cost AC power available. The low-voltage DC power outlet advantageously receives adapter plugs that are readily available for a wide range of portable appliances and other devices. Another embodiment of a furniture unit having a low-voltage DC power supply includes a computing device for controlling the recharging of the power supply and for controlling other accessories such as furniture unit lift motors, lighting, HVAC components, audiovisual components, or other such devices.

### CROSS REFERENCE TO RELATED APPLICATIONS

This application claims the benefit under Title 35, U.S.C. § 119(e) of U.S. Provisional Patent Application Serial No. 60/398,269, entitled LOW VOLTAGE ELECTRIFIED FURNITURE UNIT, filed on Jul. 24, 2002.

### BACKGROUND OF THE INVENTION

1. Field Of The Invention

The present invention relates to the electrification of office furniture and other furniture units, such as workstations, tables, and workspace panel systems used in office applications, to provide electrical outlets for powering appliances, lighting, and other equipment.

2. Description Of The Related Art

Wiring systems that provide distribution of 110 or 220 volts alternating current (AC) to office furniture worksurfaces are readily available. Such wiring systems provide electrical outlets, and are generally available as either add-on or built-in systems. However, many office appliances and other peripheral devices are now designed to operate from a low-voltage direct current (DC) power source in order to provide portability, worldwide universality of power source, and to eliminate the need for internal transformers and rectifiers. Thus, there is a growing need for a system of electrifying furniture to provide a low-voltage DC power source.

Existing DC power connections and wiring systems use a variety of receptacles and plugs, none of which constitute a universal interchangeable standard. For example, one system includes a modified AC receptacle and plug using the neutral line and ground line of a modified power grid to provide low-voltage DC. The receptacle socket and plug spade components for connecting the hot supply line of the AC power grid are removed to prevent interconnection of a DC component with an AC circuit or an AC component with a DC circuit.

With the increased usage of laptop computers, personal data assistants (PDA), cell phones, and other portable appliances, it is becoming increasingly important to provide convenient and universal electrical power outlets associated with furniture units. However, providing a 110-volts AC power source for appliances tethers such furniture to the wall or another AC power grid outlet and limits the usefulness of the furniture in countries which utilize 220-volts AC power grids.

### BRIEF SUMMARY OF THE INVENTION

The present invention provides a furniture unit having at least one low-voltage DC power outlet integrated therein. Optionally, a power supply including a universal low-voltage DC power outlet that is powered by a rechargeable battery is associated with the furniture unit. The universal power outlet is provided in the form of an automobile passenger compartment power outlet (“automobile power outlet”), such as a cigarette lighter-type outlet, thus enabling the commonly available auto adapter plugs for various portable appliances to be used to connect the appliances to the furniture-based DC power supply. Additionally, the power supply provides or is coupled with a charging circuit and/or control device that recharges the battery and can schedule recharge during times of off-peak or low-cost AC power availability or upon the unit being moved to within close proximity of an AC power grid with the power supply being connected thereto. Also, the low-voltage DC power supply can be interconnected with, or integrated into, a system which operates other furniture unit accessories, for example, an electrically driven system for adjusting the height of a worksurface or other furniture component.

One embodiment of the invention provides a power supply having a housing that is mountable to a portion of the furniture unit, such as the underside of a worksurface. The housing contains rechargeable batteries that are electrically connected to automobile power outlets. The power outlets may be mounted, for example, through a wall of the housing, or through the worksurface and thus accessible from the top of the worksurface.

Another embodiment of the invention comprises a low voltage electrified furniture unit. The furniture unit may include a height adjustable worksurface or other furniture component supported by one or more leg assemblies. Each leg assembly includes a base portion, a lift portion, and a lift motor for raising the lift portion relative to the base portion. Mounted to the furniture unit is a power supply having rechargeable batteries providing low-voltage DC to the lift motors and to power the automobile power outlets. The power outlets may be used to power portable appliances and other devices having an automobile plug adapter. A control module for controlling the furniture unit lift motors and other devices related to the furniture unit, such as lights, may be provided separately from or integrated into the power supply.

In another embodiment of the invention, a low voltage electrified furniture unit is provided that includes a computing device capable of controlling a low-voltage DC power supply or a furniture unit control module. The computing device may also provide computing power and user interfaces for typical office software applications. The computing device may be powered by the low-voltage DC power supply. Additionally, the computing device may prioritize recharging of the power supply rechargeable batteries to times of off-peak or low-cost AC power availability, or when the furniture unit is in the physical proximity of an AC power grid and the power supply is connected thereto.

In one form of the invention, an electrified furniture unit comprises an automobile passenger compartment power outlet, and a power supply electrically connected to the power outlet.

In another form of the invention, a portable DC power supply comprises a housing mountable to a furniture unit, a rechargeable battery mounted to the housing, and an automobile passenger compartment power outlet electrically connected to the rechargeable battery.

Yet another form of the invention comprises in combination, a DC power supply, an automobile passenger compartment power outlet connected to the power supply, and a furniture unit having at least one motor actuating a portion of the furniture unit, the power supply coupled to the furniture unit and capable of powering the at least one motor.

Advantageously, the power outlet provides a universal DC power source connection for an office furniture unit.

A further advantage of the electrified furniture unit and DC power supply is that the universal DC power source connection may be incorporated into existing power supplies for lighting, furniture unit actuating motors, or other DC-powered accessories.

An additional advantage is that the power supply can supply power to a portable furniture unit and the power supply batteries may be recharged during times of off-peak or low-cost AC power availability, thus providing great utility savings to the user.

An additional advantage is that many appliances already require low voltage DC power and have automobile plug adapters available and that are receivable by the universal DC power source connection.

### BRIEF DESCRIPTION OF THE DRAWINGS

The above-mentioned and other features and advantages of this invention, and the manner of attaining them, will become more apparent and the invention will be better understood by reference to the following description of the embodiments of the invention taken in conjunction with the accompanying drawings wherein:

FIG. 1A is a perspective view of a low voltage electrified furniture unit according to one form of the present invention;

FIG. 1B is a perspective view of a portion of the worksurface of the furniture unit of FIG. 1A shown with a grommet assembly;

FIG. 2 is a perspective view of a low voltage DC power supply according to one form of the present invention;

FIG. 3 is a perspective view of a low voltage electrified furniture unit according to another form of the present invention;

FIG. 4 is a perspective view of a low voltage DC power supply according to another form of the present invention;

FIG. 5 is a perspective view of a portion of the low voltage electrified furniture unit of FIG. 1, including the low voltage DC power supply of FIG. 3;

FIG. 6A is a perspective view of additional forms of supporting leg assemblies of the furniture unit of FIG. 1;

FIG. 6B is a perspective view of a lift motor and gear assembly of the supporting leg assembly of FIG. 6A;

FIG. 7 is a perspective view of a portion of a low voltage electrified furniture unit according to another form of the present invention, including the supporting leg assembly, power supply, and control module;

FIG. 8A is a front perspective view of a low voltage electrified furniture unit according to another form of the present invention;

FIG. 8B is a bottom perspective view of the low voltage electrified furniture unit of FIG. 8A;

FIG. 9 is a schematic block diagram of the electrical components of a low voltage electrified furniture unit according to one form of the present invention;

FIG. 10A is a perspective and partial cut-away view of an automobile power outlet; and

FIG. 10B is a perspective view of an automotive adapter plug.

### DETAILED DESCRIPTION

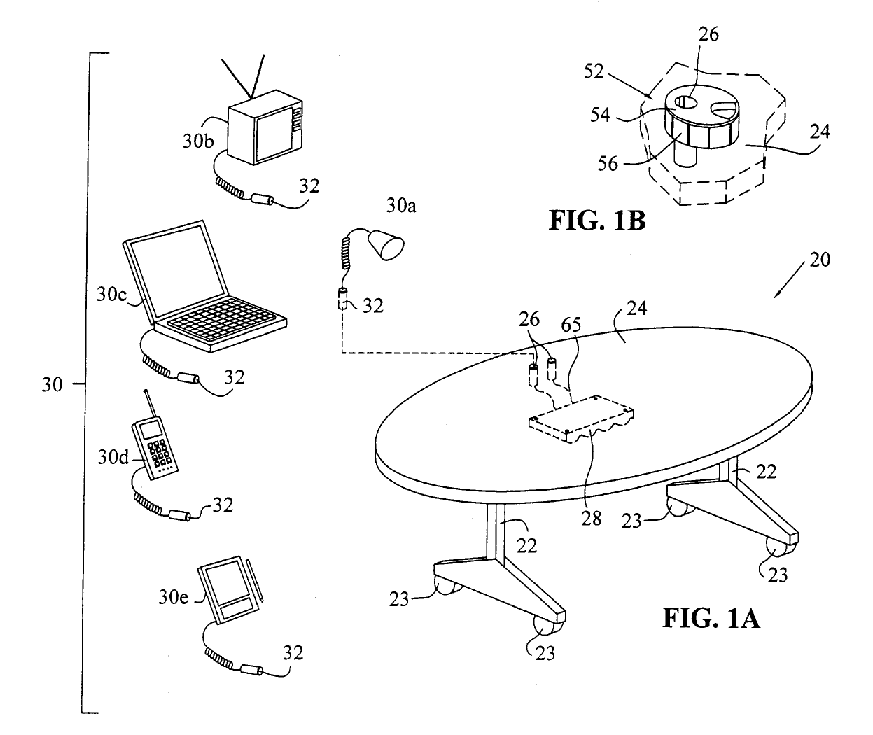

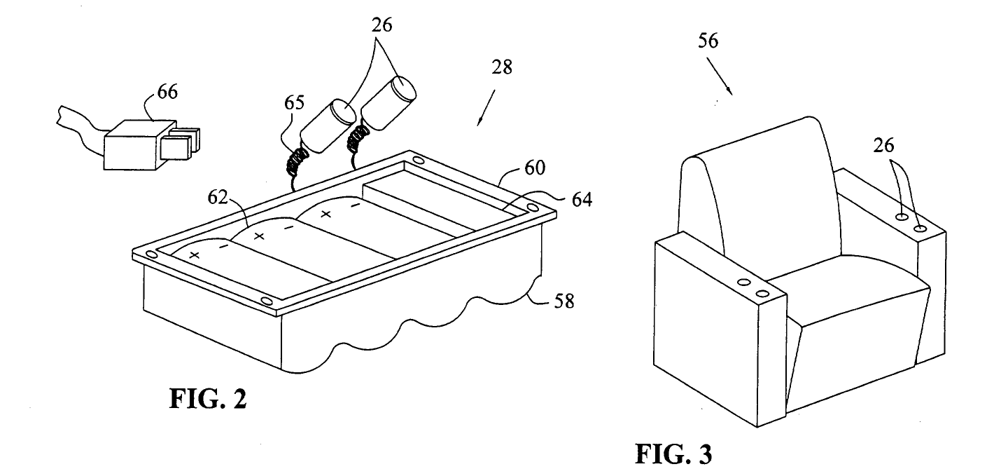

Referring to FIG. 1A, an exemplary embodiment of low-voltage electrified furniture unit 20 is shown. Furniture unit 20, which is in the form of a table, includes supporting leg assemblies 22 and worksurface 24. Automobile power outlets 26, such as cigarette lighter-type outlets, are coupled to power supply 28 and are associated with worksurface 24, so that power outlets 28 are accessible from the top side of worksurface 24. Alternatively, power outlets 26 may be associated with another easily accessible portion of furniture unit 20, for example, leg assembly 22.

Advantageously, power outlets 26 provide 12 volts DC for supplying power to portable office appliances 30 and other low voltage DC devices. Appliances 30 generally require a DC power source, and may include an automotive adapter plug 32 for connection to power outlet 26. Exemplary appliances 30 include, but are not limited to, light 30a, audiovisual equipment 30b, portable computer 30c, cell phone 30d, and PDA device 30e.

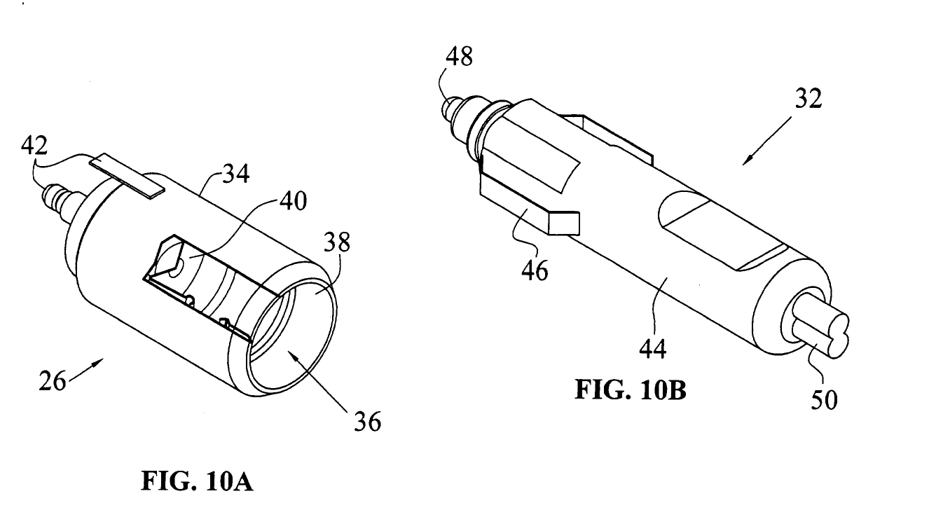

Referring to FIG. 10A, exemplary automobile power outlet 26 is shown. Although many variations are known to those skilled in the art, a typical power outlet includes cylindrical outlet housing 34 having an interior portion 36 for receiving auto adapter plug 32. Interior portion 36 includes ground contact 38, generally in the form of a metal sleeve covering a portion of interior 36, and a positive electrical contact 40 at the base of interior 36. Power outlet 26 also includes contacts 42 for supplying 12 volt DC across contacts 38 and 40.

Referring to FIG. 10B, an exemplary auto adapter plug 32 for coupling office appliance 30 to power outlet 26 is shown. A typical auto adapter plug 32 includes cylindrical plug housing 44 sized and shaped to be received in power outlet 26, ground contacts 46 along a portion of the length of cylindrical housing 44, and positive contact 48 at the insertion end of cylindrical housing 44. Generally contacts 46 and 48 include a spring action for positive engagement with contacts 38 and 40 of power outlet 26 upon engagement inside cylindrical outlet housing 34. Auto adapter plug 32 also includes cable 50 extending from housing 44 and electrically connected to contacts 46 and 48.

Although power outlets 26 in the exemplary embodiment of FIG. 1A are integrated with worksurface 20, power outlets 26 may also be located in another accessible location, for example, underneath worksurface 24 or mounted to a portion of grommet assembly 52, shown in FIG. 1B, which is located in a cable management hole of worksurface 24. Specifically, power outlet 26 may be mounted in grommet cover 54 or a surface of grommet 56 located below the top surface of worksurface 24, thus locating outlet 26 and its connected auto adapter plug 32 below grommet cover 54, which is substantially flush with the top surface of worksurface 24.

In order to provide workplace flexibility, leg assemblies 22 may include wheels 23 providing mobility for furniture unit 20 to be moved about an office space. Advantageously, power supply 28 may be chargeable, therefore providing power without being tethered to an AC power grid.

Although furniture unit 20 includes a work table or desk, the furniture unit could comprise a wide range of stationary or mobile office or home furniture. For example, as shown in FIG. 3, furniture unit 56 is shown as a chair having automobile power outlets 26. Alternatively, power outlets 26 may be integrated within a workstation, pedestal, credenza, tack panel, wall system panel, storage tower, power strip, or other furniture or office items.

Referring to FIG. 2, power supply 28 is shown. Power supply 28 includes housing 58 which is mountable to a furniture unit, such as furniture unit 20 shown in FIG. 1, by flange 60 and suitable fasteners or by another mounting device. Power supply 28 includes rechargeable batteries 62 and may also include charging circuit 64 which is electrically connected to rechargeable batteries 62 and which may include a transformer, transformer rectifier, an AC-to-DC converter, or another power converter known in the art. Power supply 28 may also include a power conditioner, for example, a voltage or current regulation circuit for controlling charging and discharging of batteries 62.

Rechargeable batteries 62 provide 12 volts DC to automobile power outlets 26. Advantageously, power outlets 26 are attached to power supply 28 via cables 65 so that power outlets 26 may be mounted separate or remote from housing 58. Power supply 28 may also include other voltage outputs, for example 24 volts, provided by other types of power outlets, such as for receiving DC power plugs other than an auto adapter plug, for example, power connector 66. Other types of power outlets, such as power connector 66 may supply power to other low voltage DC devices associated with furniture unit 20.

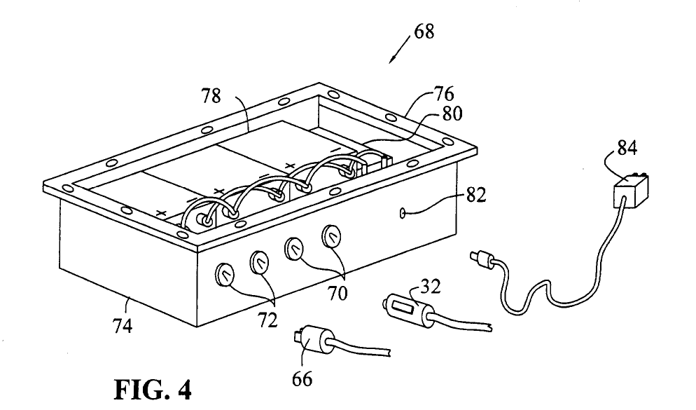

Referring to FIG. 4, another exemplary embodiment of power supply 68 is shown. Power supply 68 includes DC power outlets 70 and 72 mounted within the wall of housing 74. Power outlets 70 may be automotive power outlets, such as the one shown in FIG. 10A, for receiving auto adapter plugs 32, such as the one shown in FIG. 10B. Power outlets 72 may be other types of power outlets, such as for receiving DC power plugs other than an auto adapter plug, for example, power connector 66 (FIG. 2) for powering other low voltage devices associated with a furniture unit. Additionally, power supply 68 may include other types of DC or AC outlets having voltages of 12, 110, or other voltage levels that batteries 78, power source 84, or charging circuit 80 may be adapted to provide.

Housing 74 may be mounted to a furniture unit using flange 76 and suitable fasteners or another mounting device. Rechargeable batteries 78 and charging circuit 80 are housed in housing 74. Charging connector 82, which is electrically connected to charging circuit 80, is connectable to AC power source adapter 84. AC power source adapter 84 may provide 110 volts AC to charging circuit 80, or may include a transformer, transformer/rectifier, or an AC-to-DC converter, thus providing low voltage AC or DC to charging circuit 80.

Consequently, depending on what type of power is supplied to power supply 68, charging circuit 80 may include an AC-to-DC converter circuit. Charging circuit 80 may also include voltage or current regulation for optimal charging of batteries 78. Additionally, charging circuit 80 may be configured to preferentially provide recharging during times of off-peak or low-cost AC availability.

Rechargeable batteries 62, 78 are sealed lead acid batteries; however, other types of rechargeable batteries may also be used, such as, for example, sealed nickel cadmium batteries or other types of power storage cells. Small 6, 12, or 24 volt lead acid batteries such as those used for motorcycles and other recreational-type vehicles advantageously provide many amp-hours of use for portable appliances and may be readily disposed of through a local battery recycling program. Batteries 62, 78 may be electrically connected in series or parallel and/or a fixed or variable voltage regulator provided to supply desirable voltage levels, such as 12 volts, to power outlets 26, 70 and 72. Batteries 62, 78 may also consist of power-tool type rechargeable batteries having a connection plug or other connecting device (not shown) for releasable connection to the device being powered. Power supply 28, 68 may therefore include a socket or other connecting receptacle (not shown) for releasably receiving batteries 62, 78. Thus, power supply 28, 68 may be powered by batteries 62, 78 that when drained of power may be removed and replaced with a fully-charged replacement battery.

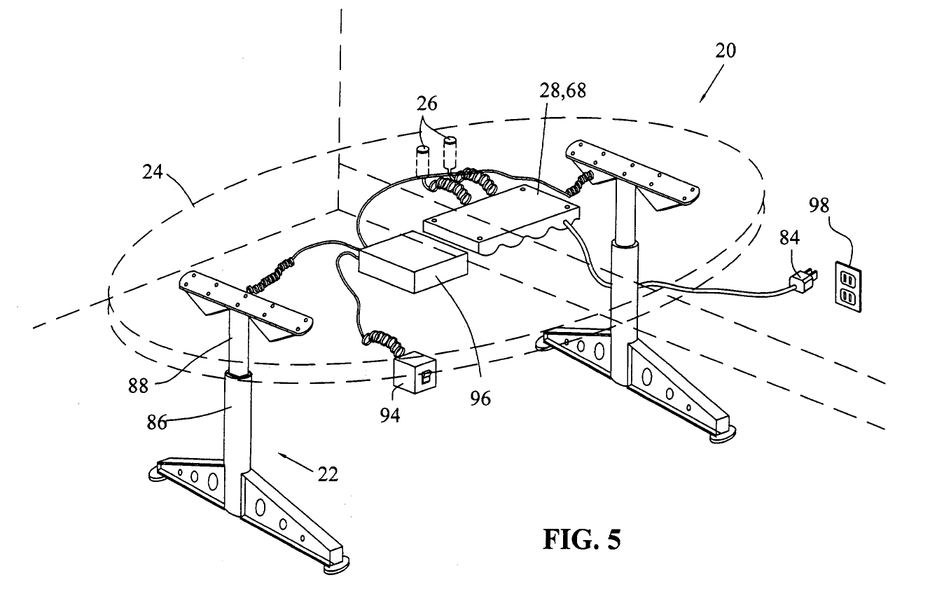

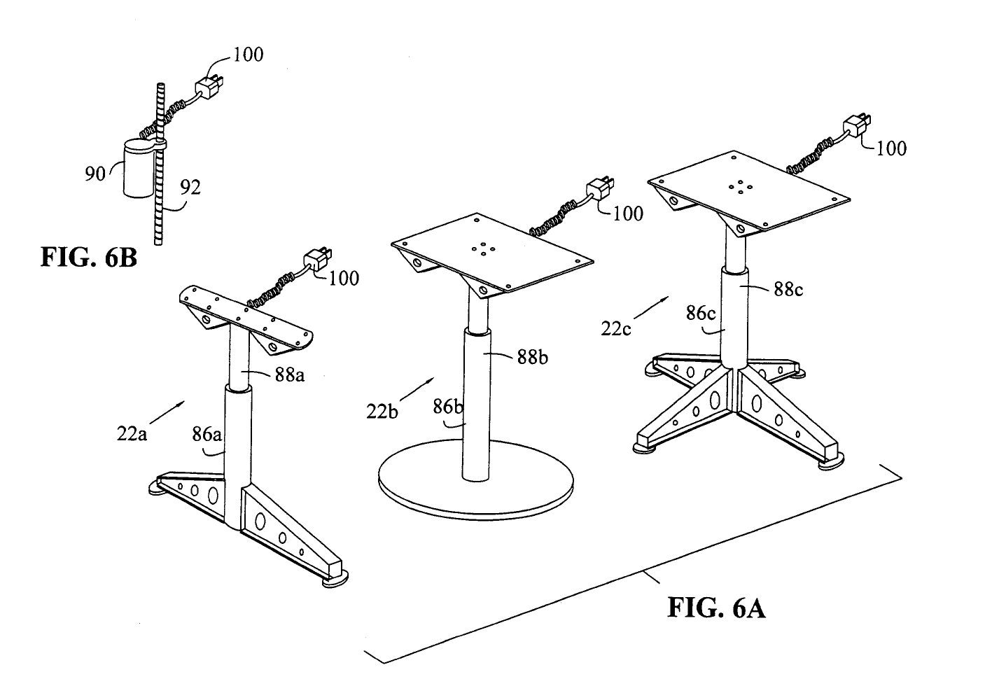

FIG. 5 depicts the low voltage electrified furniture unit 20 of FIG. 1 with worksurface 24 shown transparent and thus revealing further optionally includable components of furniture unit 20. Supporting leg assemblies 22 each include a base 86 which supports a movable lift 88. Referring to FIG. 6B, movable lift 88 includes a lift gear motor 90 and worm gear 92 for translating lift 88 vertically relative to base 86, thus adjusting the height above the floor of worksurface 24. Alternatively, movable lift 88 may comprise a different mechanism for translating worksurface 24 relative to base 86. Typically, lift gear motor 90 and worm gear 92 are enclosed by base 86 and/or lift 88.

Advantageously, lift motors 90 and power outlets 26 may both be powered by power supply 28, 168, though the voltage supplied to lift motors 90 may be 24 volts or some other low-voltage DC level, rather than the 12 volts typically provided to power outlets 26. Control switch 94 activates lift motors 90 for adjusting the height of furniture unit worksurface 24.

Furniture unit 20 may also include control module 96 for controlling the power delivered to, and the action of, lift motors 90 and for synchronizing the motion of lifts 88. Advantageously, power supply 28, 68, control module 96, and control switch 94 may be mounted to the underside of worksurface 24 where same are hidden from view. Although power supply 28, 68, control module 96, and control switch 94 are shown as separate devices, some or all may be combined in a single housing. In order to recharge power supply 28, 68, AC power source connector 84 is connectable to outlet 98 of an AC power grid. Exemplary control switches 94 and control modules 96 are available from Kessebohmer & Baumeister of Germany.

Referring to FIG. 6A, various embodiments of supporting leg assembly 22 are shown. Although each supporting leg assembly 22 includes base unit 86, lift 88, lift motor 90, gear system 92, and lift motor power supply plug 100, the exact configuration and design of each supporting leg assembly may vary structurally, functionally, ergometrically, and aesthetically. For example, as shown in FIG. 6A, the base unit may be configured as a two-leg base 86a, round pedestal base 86b, or four-leg base 86c.

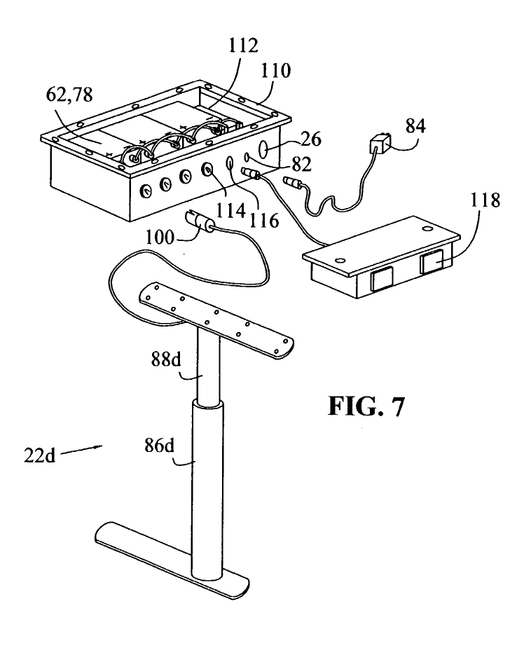

Referring to FIG. 7, exemplary supporting leg assembly 22d for supporting a worksurface (not shown) is shown along with related components. Supporting leg assembly 22d is powered and controlled by a combined power and control module 110. An exemplary power and control module is available from Kessebohner & Baumeister of Germany. Advantageously, power and control module 110 is modified by providing automobile power outlet 26 which provides 12 volts DC power at the furniture unit supported by supporting leg assemblies 22d, which includes base 86d and lift 88d. Power and control module 110 includes charging and control circuit 112, rechargeable batteries 62 or 78, control sockets 114 for receiving lift motor connector plugs 100, switch socket 116 for connecting control switch 118, and charging connector 82 for receiving recharging power from AC power source connector 84. Charging and control circuit 112 may also include a voltage or current regulation circuit or another power conditioning circuit as is known in the art. Alternatively, a power supply for powering other low voltage DC devices, such as lighting, may also be adapted by adding additional power outlets 26 and voltage or current regulator circuitry for providing 12 volts DC or other desirable power levels to power outlets 26.

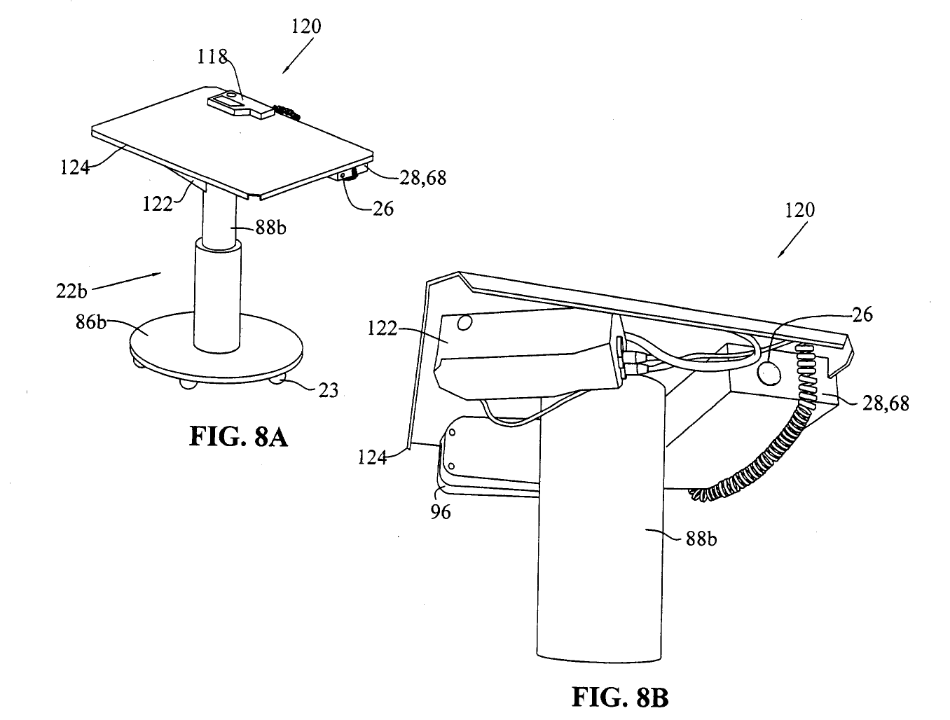

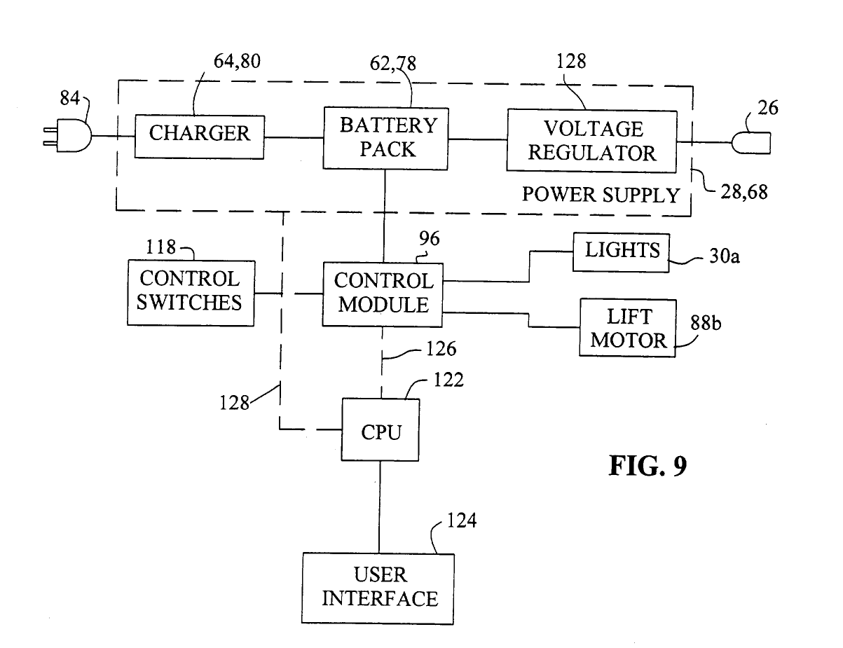

Referring to FIGS. 8A and 8B, an exemplary low voltage electrified furniture unit 120 is shown, including leg assembly 22b, base unit 86b, lift 88b, worksurface 124, power supply 28 or 68, power outlet 26, control module 96, control switch 118, and computing device 122. FIG. 9 is a schematic block diagram of the electrical components comprising furniture unit 120. Power supply 28 or 68 advantageously may include charging circuit 64, 80 powered by AC power source adapter 84, voltage regulator 128, and rechargeable battery 62, 78 for powering lift 88b of leg assembly 22b, power outlet 26, and, optionally, low voltage light 30a or other accessories. Power outlet 26 may be mounted in power supply 28 or 68 or integrated with another portion of furniture unit 120. As shown in FIG. 9, battery 62, 78 of power supply 28, 68 may also provide power to computing device 122, which in the exemplary embodiment is a computer central processing unit such as the Cappuccino Mini PC available from APTCOM, Inc., of City of Industry, Calif. Computing device 122 may alternatively be a conventional tower, desktop or laptop PC, or another computing device known in the art.

Computing device 122 may also include one or more additional user interfaces 124, such as a keyboard and monitor, for operating PC-based software applications. Additionally, computing device 122 is capable of operating ergometric management software, such as I-Fit®, available from XYBIX Systems, Inc., of Littleton, Colo. Such ergometric management software, in conjunction with computing device 122 being interconnected with control module 96 via USB 126 or other communication connection, provides graphic user interface for adjusting lift 88b to an optimum ergometric position.

Control switch 118, which operates lift 88b and/or other furniture unit 120 accessories, may be, for example, ERGO LEVEL 3™, Part No. 890 203 901, or HSS, Part No. 890 202 901, both available from Kessebohmer & Baumeister of Germany. Control module 96 may also incorporate control switch 118, for example, Part No. 890 101 901, or 890 102 901, both available from Kessebohmer & Baumeister.

As with earlier described embodiments, furniture unit 120 may combine some or all of the various electrical components into a single housing. Advantageously, computing device 122, if included, may also eliminate the necessity of control switch 118 and/or control module 96 as computing device 122 is configurable to provide hardware and software control of lift 88b, light 30a or other accessories, and operation and recharging of power supply 28, 68. For example, computing device 122 may be software configured to provide automatic or manual operation of lift 88b, light 60a, power supply 28, 68, and any other electrical components of furniture unit 120.

Computing device 122 may also provide control recharging of batteries 64, 80 so that recharging occurs only when required or during times of off-peak or low-cost power availability. In order to provide control of power module 28, 68 and/or control module 96, computing device 122 may be interconnected with power module 28, 68 and control module 96 via USB 128 or other communication connection. The exemplary embodiment of furniture unit 120 may also include casters 23, so that furniture unit 120 is mobile when AC power source connector 84 is not connected to a power outlet.

While this invention has been described as having exemplary embodiments and scenarios, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electrified furniture unit, comprising:
an automobile passenger compartment power outlet, and
a power supply electrically connected to said power outlet.

2. The electrified furniture unit of claim 1, wherein said power supply comprises a rechargeable battery.

3. The electrified furniture unit of claim 2, wherein said power supply further comprises a charging circuit.

4. The electrified furniture unit of claim 3, wherein said rechargeable battery provides 12 volts.

5. The electrified furniture unit of claim 3, further comprising a control device prioritizing recharging of said battery to times of off-peak or low-cost rate AC power availability.

6. The electrified furniture unit of claim 1, wherein said power supply comprises an AC-to-DC converter.

7. The electrified furniture unit of claim 1, further comprising a power connector that is not an automobile passenger compartment power outlet, said power connector electrically connected to said power supply.

8. The electrified furniture unit of claim 1, wherein the furniture unit includes a worksurface and said power outlet is disposed in said worksurface.

9. The electrified furniture unit of claim 8, wherein said worksurface further comprises a cable management hole having a cable management hole grommet and said power outlet is disposed in said cable grommet.

10. The electrified furniture unit of claim 1, wherein the furniture unit further comprises linear actuators adjusting a portion of the furniture unit and said power supply is adapted for supplying DC power for said linear actuators.

11. The electrified furniture unit of claim 1, wherein said power supply is adapted for supplying DC power for lighting.

12. The electrified furniture unit of claim 1, wherein said power supply releasably receives power-tool type rechargeable batteries for supplying power to said automobile power outlet.

13. The electrified furniture unit of claim 1, wherein said power supply is adapted for being electrically connected to and powering a power outlet associated with at least one other furniture unit.

14. The electrified furniture unit of claim 1, further comprising an office appliance or other peripheral device having an auto adapter plug plugged into said power outlet.

15. The electrified furniture unit of claim 1, wherein the furniture unit is mobile.

16. A portable DC power supply, comprising:
a housing mountable to a furniture unit;
a rechargeable battery mounted to said housing; and
an automobile passenger compartment power outlet electrically connected to said rechargeable battery.

17. The portable DC power supply of claim 16, where said rechargeable batteries comprise a power tool type rechargeable battery and the power supply is adapted for releasably receiving said rechargeable batteries for supplying power to said automobile passenger compartment power outlet.

18. In combination:
a DC power supply;
an automobile passenger compartment power outlet electrically connected to said power supply; and
a furniture unit having at least one motor capable of actuating a portion of said furniture unit;
said power supply coupled to said furniture unit and capable of powering said at least one motor.

19. The combination of claim 18, further comprising a control module controlling at least one of said power supply and said motor.

20. The combination of claim 18, further comprising a computing device controlling at least one of said power supply and said motor.

21. The combination of claim 18, wherein said power supply comprises a rechargeable battery.

22. The combination of claim 21, further comprising a control device prioritizing recharging of said rechargeable battery to times of off-peak or low-cost AC power.

23. The combination of claim 18,wherein said furniture unit is mobile.
